(19) United States
(12) Patent Application Publication
(10) Pub. No.: US 2016/0063440 A1
(43) Pub. Date: Mar. 3, 2016

(54) METHOD AND SYSTEM FOR PROVIDING COLLABORATION SPACE

(71) Applicant: CRS TECHNOLOGY CORP., Mississauga (CA)

(72) Inventor: KATHLEEN WEBB, Mississauga (CA)

(21) Appl. No.: 14/781,825

(22) PCT Filed: Apr. 7, 2014
(86) PCT No.: PCT/CA2014/050351

§ 371 Date: Oct. 1, 2015

Related U.S. Application Data
(60) Provisional application No. 61/808,741, filed on Apr. 5, 2013.

(51) Int. Cl. G06Q 10/10; G06Q 10/06; H04L 29/06; G06Q 50/00; G06F 17/30; G06Q 20/10; G06Q 30/02

(52) U.S. Cl. CPC G06Q 10/101; G06Q 20/10; G06Q 10/06314; G06Q 30/0214; G06Q 30/0233; G06Q 10/063112; G06Q 50/01; G06F 17/30368; H04L 65/403; G06F 17/30312

(57) ABSTRACT

A system and a method are provided for providing a collaboration space over a digital network. The system has at least crowd sourcing, crowd funding, referral giving, skill sharing, and asset sharing functionalities. The system may further include gamification features.

### PRIORITY APPLICATION

This application claims priority to U.S. provisional application Ser. No. 61/808,741, filed Apr. 5, 2013.

### FIELD

The invention relates to a method and system for providing collaboration space. More specifically, the invention relates to a method and system for providing a collaboration space over a digital network, with at least crowd sourcing, crowd funding, referral giving, skill sharing and resource sharing functionalities.

### BACKGROUND

Individuals or companies often solicit other individuals to help with projects. The Internet has allowed such campaigning to proceed on a global basis and engage far more individuals than ever before. In addition, the campaigns have similarly expanded in variety. Therefore, there is a need for a system for facilitating such campaigns.

### SUMMARY OF THE INVENTION

According to a broad aspect of the present invention, there is provided a system for providing a collaboration space over a communication network, the system comprising: a database to store a user profile and user activity history for a first user, the user profile comprising login information, user information, and user uploaded content, which comprises one or more of: (i) a crowd funding request; (ii) a crowd source challenge; (iii) information about an asset; (iv) knowledge; and (v) information about a skill; and a processor connected to the database, the processor configured to: generate and publish the user profile based on the user information and user uploaded content, to render the user profile accessible to other users via the communication network; receive and process a request from a second user to: (i) submit funding to the first user; (ii) submit a solution to the first user; (iii) share the asset; (iv) access the knowledge; and/or (v) share the skill; and receive and process a request from the second user to provide a referral to the first user, wherein the database stores the referral and associates the referral with the user profile, and wherein the processor publishes the referral on the user profile upon confirmation from the first user.

According to another broad aspect of the present invention, there is provided a method for providing a collaboration space over a communication network, the method comprising: storing to a database a user profile for a first user, the user profile comprising login information and user information; storing to the database an activity history of the first user; generating and publishing the user profile based on the user information, to render the user profile accessible to other users via the communication network; uploading content provided by the first user, and storing same in the database, the content comprising one or more of: (i) a crowd funding request; (ii) a crowd source challenge; (iii) information about an asset; (iv) knowledge; and (v) information about a skill; publishing the content on the user profile upon request from the first user; receiving and processing a request from a second user to: (i) submit funding to the first user; (ii) submit a solution to the first user; (iii) share the asset; (iv) access the knowledge; and/or (v) share the skill; receiving and processing a request from the second user to provide a referral to the first user; storing to the database the referral and associating the referral with the user profile; and publishing the referral on the user profile upon confirmation from the first user.

### BRIEF DESCRIPTION OF THE DRAWINGS

Drawings are included for the purpose of illustrating certain aspects of the invention. Such drawings and the description thereof are intended to facilitate understanding and should not be considered limiting of the invention. Drawings are included, in which:

FIG. 1 is a schematic view of sample system architecture of the present invention;

FIG. 2 is a schematic view of a computer according to an embodiment of the present invention;

FIG. 3 is a schematic view of a network configuration according to an embodiment of the present invention;

FIGS. 4a, 4b, and 4c are each a flow diagram of a sample process flow for user profile management according to an embodiment of the present invention;

FIG. 5 is a flow diagram of a sample process flow for processing payments according to an embodiment of the present invention;

FIG. 6 is a flow diagram of a sample process flow for crowd funding according to an embodiment of the present invention;

FIG. 7 is a flow diagram of a sample process flow for providing referral according to an embodiment of the present invention;

FIG. 8 is a flow diagram of a sample process flow for crowd sourcing according to an embodiment of the present invention;

FIG. 9 is a flow diagram of a sample process flow for asset sharing according to an embodiment of the present invention;

FIG. 10 is a flow diagram of a sample process flow for booking according to an embodiment of the present invention;

FIG. 11 is a flow diagram of a sample process flow for knowledge mobilization according to an embodiment of the present invention; and

FIG. 12 is a flow diagram of a sample process flow for skill sharing according to an embodiment of the present invention.

### DETAILED DESCRIPTION OF VARIOUS EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

### I. Overview

The present invention aims to provide collaboration space (sometimes also referred to as forum) in which individuals, companies, government agencies, research institutions, academic institutions, investors, entrepreneurs, advertisers, etc. can come together to share knowledge, find work, access resources, and raise funds for prospective ventures. The present invention may allow for connectivity to a trusted audience that can safely come together to achieve multiple objectives.

The present invention may also provide opportunities for fostering connections between stakeholders in the innovation ecosystem to mobilize knowledge, buy/sell/trade/share ideas, tools (e.g. software, apps, hardware, lab equipment, etc.) and technology assets, and bootstrap new product development. The present invention allows multiple functionalities to be provided in a single collaboration space, which may help provide a consistency of experience, a rationale of efficiency, and an economy of scale that comes from having a sufficiently wide breadth of audience.

In one embodiment, the present invention provides a digital forum with a networking environment in which experts, creative talents, researchers, entrepreneurs, and businesses can come together to share knowledge, find work, access resources, and even raise funds for prospective ventures. The forum allows for connectivity to an audience that can come together to achieve multiple objectives. The present invention may provide co-working spaces (sometimes also referred to “incubators”, “accelerators”, or “marker spaces”) access to materials, assets, technology, expertise, and/or services that would otherwise be out-of-reach.

Across the globe, entrepreneurs experience a common challenge in navigating a cluttered innovation ecosystem of post-secondary institutions, regional innovation centers, government agencies, trade associations, banks, investors, etc. that is dependent on referrals and recommendations. Getting through the maze of intermediaries in these organizations to reach the knowledge, opportunity, or resource that one needs can be time consuming. The present invention aims to support interactions between individuals in the innovation ecosystem to foster innovation, collaboration, and business growth at a faster rate.

With the continuing complexity of technical infrastructure needed to develop user-friendly applications for consumption by businesses and consumers alike, there is a need for resource sharing that allows individuals and/or entities to access infrastructure and/or assets that they may not be able to afford themselves.

For example, in the production of 3D movies, there is a raft of complex equipment needed to enable a production company to see how their designs will render in 3D. Many of these types of businesses are congregated in locations that are in close proximity to each other (e.g. southern Ontario, Canada) where it would be beneficial to have a common core technical centre that is accessible by all of the businesses on a rental basis, to share the expensive equipment infrastructure with similar enterprises, including potential competitors. On a more micro level, peer-to-peer sharing may also provide substantial efficiencies if firms in local areas are able to share capital equipment needed to execute specialized tasks.

Generally, crowd sourcing is where a problem or challenge is distributed to an unknown mass of people (“the crowd”) to elicit their potential input or solutions to that problem. With the advent of the Internet, the possibilities of crowd sourcing, its depth and breadth as well as targeting of problems, increased exponentially. For crowd sourcing, it is preferred that the crowd has merit, is knowledgeable and trustworthy in the feedback and/or contributions that are made to the poser of the question. Also, it is likely that in posing the question, the poser is offering a snapshot in one part of a process. For example, if a problem or question is being posed, the poser likely has an intention to do something with the resulting information that the crowd elicits.

Funding for ideas and opportunities from the crowd is commonly referred to as crowd funding. The Internet has opened the doors to both the potential access to new ways of funding as well as unscrupulous characters seeking to illicitly extort funds from unsuspecting investors. Crowd funding is a useful mechanism to source investments for innovative new ventures but there is a need for a credible space in which investors can place some trust on the identity of the prospective investee. Preferably, investors need to know that their investment is legitimate and protected (financially and morally) by an authoritative body, and investees need to know that the space a safe place in which to share their ideas and creativity freely, without the fear of plagiarism or unscrupulous extension.

### II. Functions

In one embodiment, the present invention has one or more of the following functions:
1. Providing a repository of creative assets, including:
   a. Learning assets—for example, online postings that are of relevance and help to the audience. The contents of the postings may be of various formats, including for example videos, reports, presentations, research papers, interactive tools, interactive applications, etc.
   b. Portfolio development—for example, individuals and/or businesses may develop a portfolio to showcase their talents to express their capabilities and interests to prospective project posters and/or enquirers.
   c. Creative assets—for example, individuals and/or enterprises may place creative assets (e.g. applications, software, designs, concepts, etc.) for sharing or remixing with others in the collaboration space of the present invention.
2. Providing a crowd and/or audience for various purposes, including:
   a. Crowd sourcing—for example, projects may be posted by any party wishing to access the crowd through the collaboration space of the present invention for information, communication, and/or interaction.
   b. Crowd funding—for example, projects may be posted by any party wishing to access the crowd through the collaboration space of the present invention for soliciting funding.
   c. Offering funding—for example, government, banks, venture capitalists, angel investors, business, etc. may post their offers for funding for viewing by businesses and/or individuals.
   d. Asset sharing—for example, individuals and/or enterprises may place their assets (e.g. equipment, space, sets, etc.) that can be shared and/or rented by others in the collaboration space of the present invention.
3. Providing access to expertise for projects:
   a. Technology solutions—for example, technical solutions and prototypes may be displayed and interacted with, for “hands-on” testing, experimentation, and trials, through the collaboration space of the present invention.
   b. Job recruitment—for example, post-secondary institutions and enterprises may post job postings to seek new talents through the forum of the present invention.

### III. Architecture

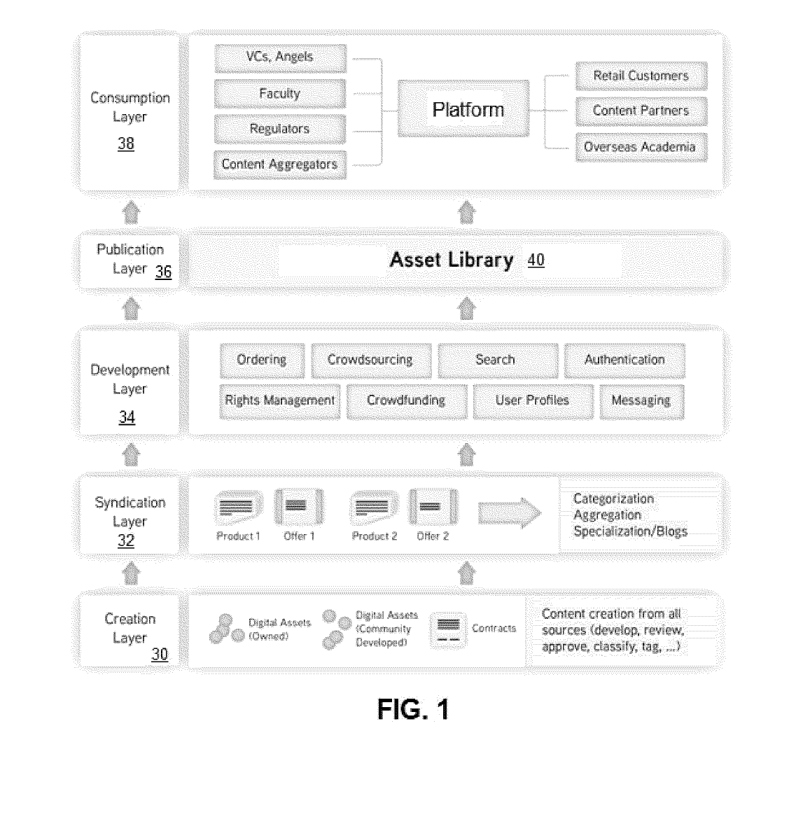

In a preferred embodiment, with reference to FIG. 1, the present invention has a five-tier technical architecture:
1. Creation Layer 30: This is the point at which content is created and uploaded to the system of the present invention. The contents include for example assets, skills, profile contents, new profiles, etc. developed by creative talent, or submissions from enterprises seeking crowd sourcing input. Any item of content uploaded may be reviewed by system administrators for approval.
2. Syndication Layer 32: The created and approved content is then syndicated into relevant identities. There may be categorization to enable user profiles to be sorted against relevant offers or projects, and to allow for subsequent specialization and potential communication opportunities to be aggregated as a result of the “total” of all projects or offers that have come through the system.
3. Development Layer 34: Once syndicated and categorized into relevant modules the contents are developed and tagged with the necessary applications prior to publication. Each application is decided by the rules and protocols that are relevant in each unique instance, for example depending on the scale and breadth of audience determined by the poster, the type and scale of feedback required (e.g. for a crowd sourcing project), and potentially separated by the volume of revenue needed in a crowd funding context.
4. Publication Layer 36: The contents are then published to the relevant community and copied to an asset library 40 of the system (e.g. a database). The asset library serves as the repository of all the contents, and as such provides the opportunity for cross-referencing. As each piece of content gets published, the system may further enhance the value of the forum through the cross pollination of ideas and relevant topics.
5. Consumption Layer 38: This is the point at which the offers and contents are interacted with and acted upon, either via direct links to identified pre-assigned communities and/or to the widest audience depending on the original audience objectives of the offer or content.

### EXAMPLE 1

The following chart shows how students and faculty interact with the system of the present invention across the layers, from initial creation through to consumer consumption. The bottom row describes the system's value proposition across each layer.

### IV. Gamification

In one embodiment, a gamification program may transect the layers of the present invention. Gamification is the use of game-thinking and game mechanics in a non-game context in order to engage users and solve problems. Gamification may be used within the system to help improve user engagement, return on investment, data quality, timeliness, and learning.

In one embodiment, the gamification program rewards users for their engagement in the community within the collaboration space of the present invention. For example, individuals may be rewarded for joining the community, sharing knowledge and assets, supporting challenges, and promoting the community. Rewards may be in the form of points. The idea is that members will “get by giving,” in that points allocated through the gamification program may be used by members to purchase or utilize across other areas of the networking environment. The points are awarded such that the more contributions a member makes to the community, the more points will be awarded to the member.

Further, rewarding both supply-side and demand-side member actions within the collaboration space may help develop a sustainable, critical mass of participants for the collaboration space. A gamified rewards system may help engage members to participate in the collaboration space in a deeper, more sustainable manner. In one embodiment, all solution offering members are rewarded whether or not their solution is chosen by the challenger. This approach may increase the number of members offering solutions to challenges.

In a further embodiment, the system of the present invention may host its own currency system that may be used on a barter basis for accessing other services within the collaboration space. For example, a certain number of points may be traded for two hours of a user interface designer's time.

In one embodiment, points are awarded either once payment has been made and deposited into the bank account associated with the system or once actions have been verified by a trusted party. In a further embodiment, points are allocated to accounts retrospectively, such that points cannot be allocated before the corresponding payments and/or transaction have occurred.

Further, users may be encouraged from time-to-time to perform certain actions, such as posting on their profiles (for free), and may receive points in return for performing the actions. There may be a monetary value equated to each point and points may be used in place of cash.

In one embodiment, points are allocated to members of the system on an individual basis. Members who are employees or part of an enterprise that is a sponsor or contributor to the system may contribute under their own profile in an individual capacity. Preferably, the points individuals earn are a personal attribution and are associated with their own profile, but not linked to their employer or association.

In one embodiment, points are allocated for creating a personal profile, for uploading a video posting, original content and/or thought leadership, and/or completing administrative components (including identity verification). Members who respond to a challenge may also be awarded points to encourage contributions to the challenges posted by entities and organizations through the forum.

In a further embodiment, an entity or individual that offers to share assets in the collaboration space for rent may be awarded points once their asset has been rented and paid for. In one embodiment, the points level is a reflection of the monetary value of the rent that was paid.

In a still further embodiment; when a member posts a challenge in the forum they may be awarded a base level of points that is a reflection of the monetary value of the posting they have made. They may subsequently be awarded additional points based on the level of response received (i.e. the more response they receive, the more points they get).

In a further embodiment, a member who posts an offer to the forum that is subsequently activated and paid for (depending on the activity required) may be allocated points.

Table 1 below lists sample tasks and actions for which points may be rewarded within the system:

TABLE 1

| Task | What/With who |
|---|---|
| Contribution | Links to articles |
| | Knowledge, open educational resources |
| | Assets-labs, code, software, hardware |
| | Photos, videos |
| Rating/Reviewing | Pitches |
| written feedback | Videos |
| | Business plans |
| | Blog posts |
| | Profiles |
| Creating content | Blog posts |
| | Videos |
| | Profiles |
| | Project profiles |
| | Missions |
| | Crowd funding project |
| Mentoring | Any member |
| Skill Sharing | Any member |
| Collaborating | On a team |
| Leading, managing | Innovation team |
| Complete survey, polls | IC or member |
| Referrals | Any member |
| Provide sales leads | Any member |
| Funding | Fund a project with money |
| | Fund a project with points |
| | Fund a project with time (skill share) |
| | Fund a project with time dollars |
| Actions | Event, seminar |
| | Hosting events |
| | Join forum |
| | Location check-ins |
| | Test a product |
| | Pitch, respond to a challenge |
| | Deploy ad campaign |

In another embodiment, a user may be awarded points if the content uploaded by the user is popular. For example, the system may award points to a user if a video she uploaded is viewed by 100 users. The system may grant additional points if the number of viewers reaches 200, etc. In a further embodiment, a user may voluntarily give her points to another user who is a content provider, if the user likes the content that is provided by the content provider.

Optionally, the system may include different status levels for different points level. For example, a member with an accumulation of 1000 points is awarded the bronze level, and a member with 5000 points reaches the silver level, etc. In a sample embodiment, when a member completes an action such as those mentioned above, the system may display a pop-up window to inform the member of her points level and her status level, and optionally inform the member of the number of points required to reach the next status level. A member's points level and/or status level may be a reflection of the member's reputation in the community of the collaboration space.

In a further sample embodiment, points can be used as full or partial payment for services within the system. This allows, for example, a points-holder the ability to engage with expertise and members of the forum to enlist support for their projects or activities without necessarily needing to expend cash directly. For example, a first member wishes to use a production facility that a second member has offered as an asset to share, at a price of 10,000 points per hour (or part thereof), but the first member only has 5,000 points in their system account, then the first member may rent the asset by paying 5,000 points and the remaining cost in cash.

In one embodiment, members can post the points value and price of their expertise, assets, and/or services. For example, a professor who is a recognized expert in digital pricing may post his thought leadership and content on the area of pricing for new business models. A member may seek to gain an hour of the professor's time to consider a new business proposition and therefore pay for that time in points. The professor then receives the points that she can bank within the system and subsequently use to pay for a crowd-sourcing project in relation to a separate research study she is conducting.

If a member is asking for a level of points that is too high for their services, expertise, and/or assets, they probably will not receive any offers of points from other members, and if the asking points level is too low, the member may potentially be overwhelmed by the number of requests or incapable of fulfilling the requests they receive. In this way, the system allows a self-regulating method of point allocation without the need for extensive resources to monitor or manage the process.

In one embodiment, members may use their points to pay for services such as crowd sourcing. If they are looking for 100 responses and are paying on a ‘cost per click’ basis (e.g. either 10 points per response or $0.20 cash) they could pay in points up to their limit of existing points, and then in cash for the additional responses they require.

In one embodiment, instead of making money contributions to crowd-funding requests, a user may make crowd-funding contributions using her points. In a further embodiment, a user requesting crowd funding may offer her points in exchange for another user's cash contributions.

In one embodiment, member profiles include a function that allows the members to manage their points. Further, the points system may be integrated to the payment system such that payments made through the system may be made either via cash (e.g. credit/debit card), points, or a combination thereof.

The system allows a member to see their points balance. In one embodiment, a user's points level can be seen by all or selected other users. In a further embodiment, the system may be configured to allow members to gift or donate points to members of their choice. For example, the system may allow members of a small company to aggregate their points to allow them enough capital to engage a product test. In one embodiment, there is no cash value or “buy-out” value of the points. Points are preferably only redeemable on products and/or services available through the system.

In addition to points, the system may allow members to rate other members, for example by awarding stars, in recognition of certain actions, experience, received referrals, etc. The number of stars a member has may be a reflection of her reputation in the community within the collaboration space.

Alternatively or additionally, the system may award virtual badges and/or trophies for various higher-level actions and achievements, such as for example, mentoring, joining a team, winning a challenge, etc. Badges and/or trophies may also be used for recognizing progression across achievement levels and/or points levels.

For example, members of the community who are involved in a start-up may not have direct access to funders within the community until they reach an achievement level, such as a “start-up” badge or “expert” badge, which may be obtained by uploading all team member profiles for the startup, plus completing the product/service profile, etc. In another example, members may be invited to an 8-step “innovation” journey—e.g. from novice to expert—where the members can achieve levels of community status based on engagement. For example, in one embodiment, the levels of community may be “Profiler”, “Contributor”, “Reviewer”, “Collaborator”, “Mentor”, “Promoter”, etc. Badges may also be used to delineate levels of reputation within the community, based upon achievement of tasks and/or contributions.

In one sample embodiment, badges may be used to help identify a user's role and/or expertise on the platform. For example, there may be a variety of badge names including “start-up”, “animator expert”, “collaborator”, “marketing expert”, “product packaging expert”, etc. In a further embodiment, a user may participate in skills sessions and/or courses via the system (e.g. via webinars, videos, interactive applications, etc.) to qualify for and earn a badge that is of a higher level than the user's existing badge. In a still further embodiment, the system may grant a user an “expert” badge for a particular subject if the user offers skill-development services and/or courses for that particular subject and has provided the services and/or courses to a certain number of users (e.g. 5) and has received referrals from all of those users.

In another sample embodiment, a user may earn a particular badge by performing certain tasks. For example, a user may create a “mission” (also sometimes referred to as a “request”) on the platform and earn a badge. A “mission” includes for example, a job offer posting, an asset description posting, a skill offer posting, etc. In another embodiment, a user may receive a badge for simply signing up and completing her profile.

In a further embodiment, a mission may have in itself multiple levels. For example, one of levels may be reached by entering information such as company information, job description, location, deadline, work description, skills required, etc. To reach the next level, the user may be required to upload additional information (e.g. documents, videos, apps, etc.).

The user may provide the additional information herself or recruit another user to provide the necessary information to reach the next level. If the user recruits another user to provide the information, the other user may earn a badge and/or points for completing her profile and she may receive another badge and/or additional points for providing the additional information as requested. In a further embodiment, the user who requested the additional information receives points once the system receives the additional information from the other user.

In a sample embodiment, the system may allow a user to decide the types and number of levels within a mission. For example, the system may present the user options in terms of potential categories of mission levels to help the user “build” her mission. In one example, the user may use the following levels for a mission where the user is offering a job:
Level 1—Indication of interest to apply for the job
Level 2—General information on the candidate
Level 3—Complete a skills test
Level 4—Interview
Level 5—Successful applicant

In one embodiment, the user (“job poster”) may also choose data fields for which a prospective job applicant should enter to reach a particular level. While building the mission, the job poster may also decide whether to award an applicant points (and the number of points) and/or badges for reaching a level. For example, the job poster may pay a fee to the system for posting the job offer. Upon receiving the fee, the system may provide the job poster with a number of points, which the user may use to reward job applicants for reaching certain levels of the job offer mission.

Additional information or materials may be required for certain levels. For example, the job poster might be required to formulate and/or provide the skills test to job applicants for Level 3 above. The job poster may provide the skills test herself or recruit another user to provide the test. If the user recruits another user to provide the test, the other user may earn a badge and/or points for completing her profile and she may receive another badge and/or additional points for providing the test as requested. In a further embodiment, the user who requested the test receives points once the other user uploads the test.

Once the job poster is finished designing the mission, the job poster submits the mission to the system for review and pricing. The system then notifies the job poster of any missing information, the fee for posting the job offer, and payment details. When the job poster has submitted the fee and the payment has been processed successfully, the system allows the job poster to publish (also referred to as “launch”) the mission. Upon publication of the mission, the system may optionally award the job poster points and/or a badge.

The system may publish a mission to all or selected members. For example, if a mission is a job offer for an animator, the system may send the mission to a community of users or to only users who have indicated animation expertise on their profile. In a further embodiment, users may refer other users (whether members or non-members) to the job posting. In one example, if the referral results in another user signing up as a member and/or completing a certain level of the mission, the referee may receive points and/or a badge.

The user who posted the mission and, optionally, any user who contributed to the building of the mission, may receive a notification from the system when a candidate accepts the mission and/or has reached a certain level of the mission. Additionally or alternatively, the system may provide a real-time or a periodic count of the number of candidates who have reached each level to the poster, and/or any user helping the poster with the mission, through a graphical user interface. When a user accepts a mission and/or reaches a certain level within the mission, a badge and/or points may be awarded to that user.

In the job posting example, a user (“job applicant”) who wishes to complete the skills test may search for materials on the platform to help her prepare for the test prior to the starting the skills test. For example, the job applicant may search for instructional videos on the platform that are related to the subject matter of the skills test and/or consult an expert in the subject area through the platform. In one embodiment, the job applicant may be required to pay for the test prep materials and/or expert with money and/or points.

The user who provides the skills test may review and grade the test responses herself or may recruit other user(s) to help. In one embodiment, when the grading is completed, the user(s) who conducted the grading may receive a badge and/or points.

After the grading is completed, the system displays to the job poster how many and which candidates have passed the test. The job poster may then conduct candidate interviews herself or recruit other users to help. When the interviewing process is complete, the user(s) who conducted the interviews may receive a badge and/or points. Candidates who were successful with the skills test but were unsuccessful at the interview may be awarded a badge and/or points. The winning candidate (i.e. the user chosen by the poster and accepts the job/contract offer) may also receive a badge and/or points.

Once the winning candidate completes the job, the candidate may make a request to the job poster for a referral. If the candidate receives a referral, the system may award a star to the candidate, in recognition of the referral.

Another gamification scenario is to enable members to be rewarded for responding to missions and/or challenges posted by other members, including for example, responding to a crowd-sourcing request, viewing a video on YouTube™, or giving feedback on a draft website copy. Challenges may be small, high volume transactions that can help build community and recognize effort.

In one embodiment, the system may offer money as a reward for certain events, for example, for completing and/or winning a challenge. In a further embodiment, the system may have an “honor roll” system where certain members are profiled and displayed for reaching a certain points/stars level or obtaining certain badges/trophies and/or for obtaining the highest points/stars level within a community. The profiled members may be displayed on a “leader board”-type listing.

In a further embodiment, the system may give a member time dollars, i.e. points and/or a credit for the amount of time the member spends on completing a task for other members. The corresponding points and/or credit may be redeemed for services from other members in the collaboration space.

The system may also provide members with feedback on how well the member is doing in achieving her end goal. For example, the system may display a progress bar to a user through a graphical user interface to show the percentage of the user's mission that has been completed.

### V. Users

The present invention may be useful to a range of individuals and entities, including for example creative talent, technology suppliers, post-secondary institutions, investors, and enterprises of all shapes and sizes. Each entity and/or individual may have varying needs depending on the specific objectives of the projects or offers they are attending to at particular moments in time.

A. Creative Talent

Creative talent includes for example individuals with innovation related skills and/or knowledge-seeking opportunities to apply their talent, whether for free or for hire. For example, creative talent may use the present invention to: (i) seek opportunities to be part of a crowd sourcing project for potential paid work contracts or collaborations; (ii) showcase skills and knowledge through their portfolio, how-to videos, photos of their work, whitepapers, etc.; (iii) search for challenges in the forum and respond by sharing concepts to solicit paid work; (iv) develop challenges to find collaborators to work with or fund their personal projects; and/or (v) participate in crowd funding initiatives or earn incentives for projects seeking skills or expertise.

Creative talent may set up an online profile through the collaboration space to post a description of themselves and their skills, talent, and/or experience, using various types of media and/or uploading various contents, including for example, videos, photos, text, artwork, etc. The profile may include links to works (e.g. white papers, research articles, books, digital art, etc.), links to other social media network profiles and/or contents (e.g. LinkedIn™, YouTube™, Google+™, Twitter™, etc.), and/or links to other websites, including corporate websites. Through the forum, others can view these profiles and potential employers and/or collaborators may gather sufficient information from the profiles to engage the creative talent for paid work or collaboration.

Creative talent may post and/or upload information about themselves that is not directly related to the services the individual is intending to be contracted for. For example, a teacher that has been teaching the use of colour for the past 20 years at an arts institute may post informative videos on how to use colour to motivate behaviour in online games. Through watching the video, the viewer may have an understanding about the person who posted the video and the person's professional experience, without having viewed other information about the person.

B. Technology Suppliers

Technology suppliers include for example enterprises and/or individuals who have technical skills to develop digital products. Technology suppliers may use the forum of the present invention in a number of ways. They may use the crowd sourcing functionality to assess new ideas or concepts that they wish to bring to market, and may use crowd funding if they wish to access resources to get to market. Further, they may promote their competence and even upload beta or test versions of technical solutions that prospective users may try in order to give valuable hands-on feedback. Technology suppliers may also share their capital assets by making them available for rent through the forum of the present invention. In one example, technology suppliers may supply software to other users for free under an open source licence or for a fee under a licence.

Still further, technology suppliers may use the forum to showcase their prior endeavors via uploaded videos, which may provide more information about their offerings than typical brochure material. The present invention may afford technology suppliers broader market reach and may help increase the effectiveness of getting their messages to the market.

C. Post-Secondary Institutions

Post-secondary institutions include for example universities, colleges, technical institutes, and researchers that may or may not be associated with an academic institution, etc. Post-secondary institutions may, through the forum, provide verification of the authenticity and/or credentials of certain users, for example through their enrollment records and/or their degree or certificate grant records. Post-secondary institutions may also, through the forum, build their own brand and credibility for the online community through the allocation of contracts and description of projects that they are seeking to execute.

Using the present invention, post-secondary institutions may seek opportunities related to their research, whether for free, in-kind, or for hire. Post-secondary institutions may also use the forum to showcase their skills and knowledge. For example, post-secondary institutions may post links to their lab website, how-to videos, photos of their research team, past awards, research papers, etc.

Further, post-secondary institutions may use the forum to search for talent challenges and/or project opportunities for their students, for their researchers, and/or for themselves. Post-secondary institutions may also develop and post their own challenge in the collaboration space to find testers for their research results, to find research collaborators, and/or to solicit funding for their research projects. Post-secondary institutions may offer to share their assets in the collaboration space, including for example making their lab space available for rental, perhaps during off-peak times. Post-secondary institutions may also share another user's assets, including for example using some open-source software for teaching or demonstration purposes.

Through the forum, the online community may provide: (i) a networking environment for sharing academic research projects amongst various users; and/or (ii) an interactive and collaboration space through which various users can address problems and challenges together. For example, the types of problems and challenges may range from one-line questions to full PhD projects.

In a further embodiment, the forum may also host a feedback forum in which critiques, experiences of successes, and/or challenges are shared within a community. The feedback forum may over time help build a strong network of connections between various users and academic institutions that can foster next generation prospective entrepreneurs, and may further help add content to academic courses.

D. Investors

Investors include for example venture capitalists, angel investors, banks, businesses, entrepreneurs, etc., and may or may not be associated with an academic institution. Investors may use the present invention to identify investment opportunities and/or promote their own services and/or special interests. The investors may use the forum to post contents that highlights their particular avenues of interest, and may also show contents to demonstrate what they are looking for in terms of investment opportunities. Some contents posted by investors may be used as case study material by students, who for example study business planning. The contents posted by investors may also serve as educational material for potential investment fund applicants, in terms of what they should emulate if they wish to be successful in applying for funding.

E. Enterprises

The system of the present invention may be used by various enterprises, including for example:
Public sector enterprises, including enterprises that are government funded, such as schools and hospitals. Public sector enterprises may be municipal, provincial or federal in nature. Public section enterprises may use the present invention to: (i) access a known audience to acquire new ideas and test concepts (e.g. through crowd sourcing); (ii) identify research collaborators; (iii) assess and develop research ideas before introducing them to other public domain facilities; (iv) build a project team by establishing connections to qualified individuals or entities; and/or (v) share software for free or for a fee (e.g. a mobile app).
Not-For-Profit (“NFP”) enterprises, including for example charities, may use the present invention to attract other entities and find opportunities to develop relationships for projects and programs. For example, NFP enterprises may seek to collaborate with other enterprises (whether public or private sector) through the forum such that they can for example: (i) crowd source to help develop ideas and/or concepts for a potential fundraising initiative; (ii) solicit support from other enterprises with similar values and objectives; (iii) crowd fund to help in the fundraising initiative; and/or (iv) to access mentors, technical assets, talent, rent event space, etc.
Small and medium enterprises (“SME's”) may use the collaboration space for various purposes. Firstly, the collaboration space may allow SME's (temporary) access to certain skills, tools, technology, infrastructure, and/or services that may typically be outside their sphere of reach or budget. Secondly, the collaboration space may allow SME's to use the skills, thoughts, and talents of academic institutions and the network of associated talent to, for example, crowd source thoughts and ideas on potential new products and services, as well as to pilot and/or receive feedback on their future ventures, which may provide significant value in the commercialization process of projects. SME's often require specific skills temporarily and/or sporadically (e.g. help with marketing for a product launch). The collaboration space of the present invention may provide SME's access to experts who can help with short term high value tasks or highly talented students who can provide these services very cost effectively. Thirdly, when corning to market, the collaboration space may allow SME's to find collaborators or direct work projects from the creative community via the system's networking environment. The collaboration space may also help SME's book physical space, for example for meetings and events, and the physical space may be at one of the co-working space member facilities.
Large enterprises, including large corporations, have the potential to help sponsor projects and students via the collaboration space. The collaboration space may help large enterprises to directly assess the appeal of new technology, products and/or services to certain groups, such as students. The collaboration space may also help large enterprises with potential employee recruitment. For example, the collaboration space has an audience of students and academia, which may provide an innovative community for large enterprises to explore and exploit.
New business start-ups, including new businesses in their own right and ideas of executives or creative minds from other areas, may: (i) access crowd sourced feedback on new products; (ii) access technical assistance and potential funding; and/or (iii) solicit advice and feedback on key business essentials such as grants, incentives and tax breaks. Also, the collaboration space may provide a place for new businesses to access potential talent to fill gaps in knowledge or offerings that may assist in getting their product or service into the appropriate market(s). This may be helpful for specialized services that are required only once or sporadically (e.g. product packaging). The collaboration space may also provide start-ups with access to specialized equipment and/or physical spaces (e.g. for meetings and/or events).

F. Co-Working Spaces

A co-working space is a physical location where local entrepreneurs, makers and start-ups can rent space and access on-site resources in support of their individual projects. A co-working space may be a user in the system and have its own user account. In one embodiment, the system allows multiple renter members of the co-working space to access the assets, services, etc. offered on the platform through the single co-working space account. Renter members may each be an individual user of the system and may or may not be associated with the co-working space account. In one embodiment, the system awards the co-working space account a commission in points whenever its renter members earn points themselves. The co-working space may offer their assets and/or services to other users through the platform.

G. Subscribers vs. Non-Subscribers

In one embodiment, the system may be configured to be accessible for only subscribers (also referred to herein as “registered users” or “members”). A subscriber may be an individuals or an entity. In another embodiment, the system may allow limited or unlimited access for non-subscribers (also referred to herein as “unregistered users” or “non-members”), especially in situations where a wider representative sample audience may more accurately reflect the market reaction to a potential product. In one embodiment, the system allows non-subscribers to: (i) participate in crowd funding initiatives; (ii) purchase products and services; and/or (iii) participate in surveys.

For example, an artist with a new range of digital gift cards may want to see how the public at large feels about her designs, rather than restrict the feedback from only the subscribers of the system. Further, the artist may wish to seek support from family and friends for her business venture, and the system may provide an effective way to enable the artist to solicit and receive donations from subscribers and non-subscribers. In another sample embodiment, the system may allow non-subscribers to purchase advance copies of a soon-to-be released product (e.g. a mobile app), which may allow the product's developer to solicit valuable initial feedback. Further, the system may forward vouchers, for example via other social media, to non-subscribers to enable a broader audience to access and try out the system for a limited time, which may help persuade non-subscribers to become subscribers.

### VI. System Configuration

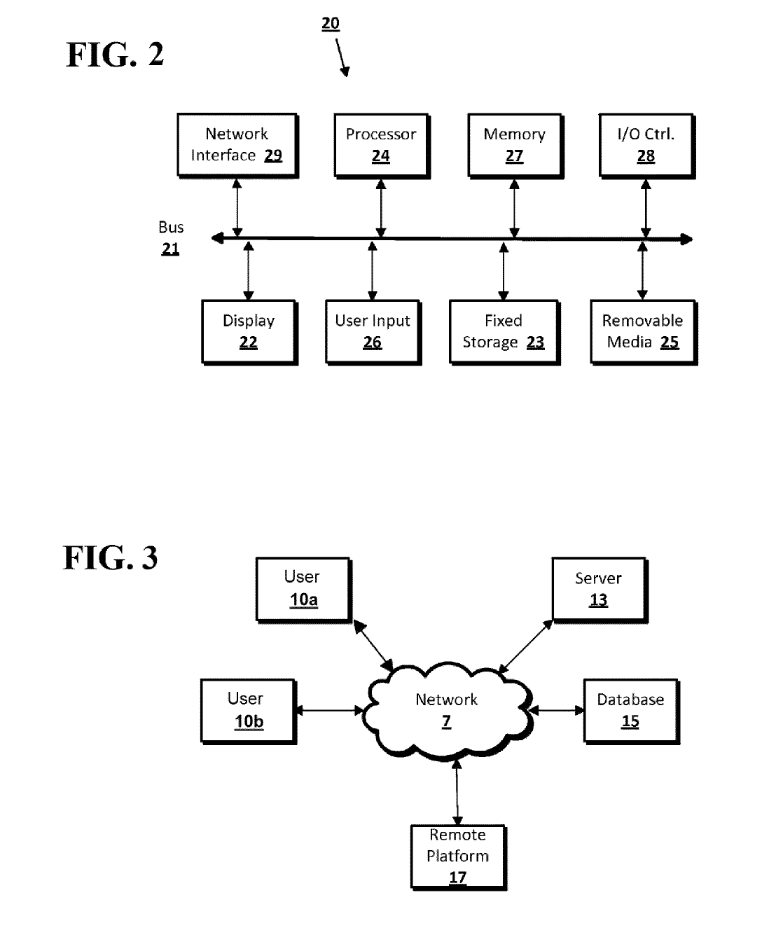

Implementations of the presently disclosed subject matter may be implemented in and used with a variety of component and network architectures. FIG. 2 is an example computer 20 suitable for implementing implementations of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, touch screen, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

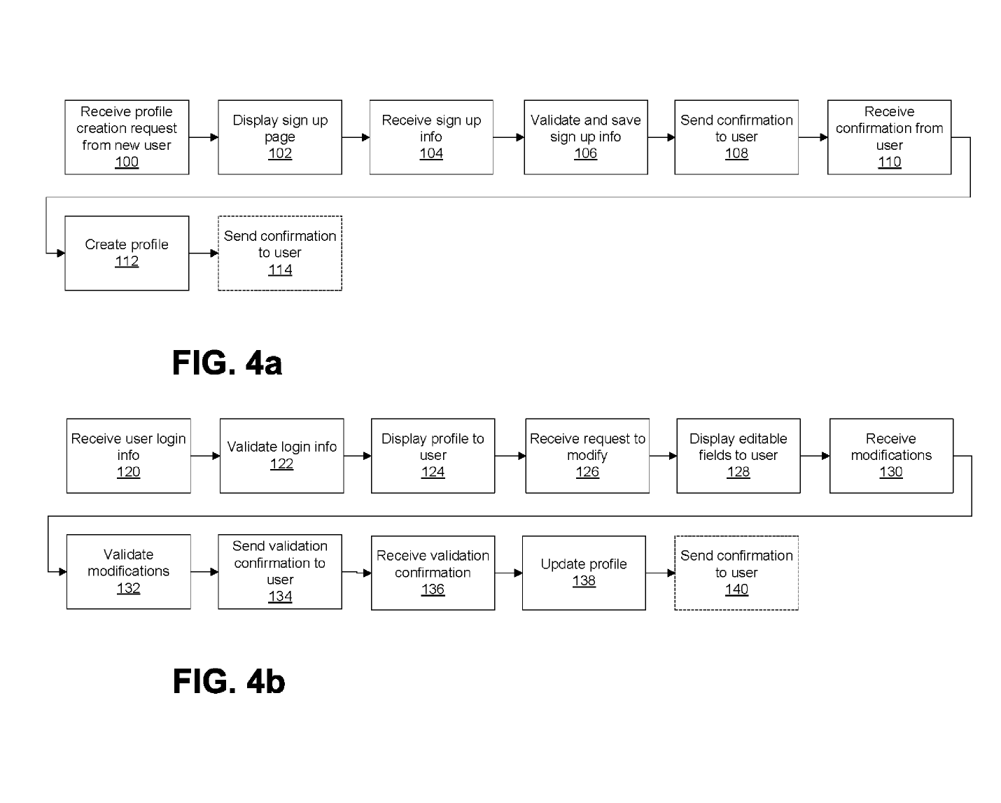

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 3.

Many other devices or components (not shown) may be connected in a similar manner (e.g., document scanners, digital cameras and so on). Conversely, all of the components shown in FIG. 2 need not be present to practice the present disclosure. The components can be interconnected in different ways from that shown. The operation of a computer such as that shown in FIG. 2 is readily known in the art and is not discussed in detail in this application. Code to implement the present disclosure can be stored in computer-readable storage media such as one or more of the memory 27, fixed storage 23, removable media 25, or on a remote storage location.

FIG. 3 shows an example network arrangement according to an implementation of the present invention. In one embodiment, the system of the present invention comprises one or more servers 13 and on or more databases 15. The system may further comprise one or more remote platforms 17. One or more users 10a, 10b, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The users may communicate with one or more servers 13 and/or databases 15. The devices may be directly accessible by the users 10a, 10b, or one or more other devices may provide intermediary access such as where a server 13 provides access to resources stored in a database 15. The users 10a, 10b also may access remote platforms 17 or services provided by remote platforms 17 such as cloud computing arrangements and services. The remote platform 17 may include one or more servers 13 and/or databases 15.

More generally, various implementations of the presently disclosed subject matter may include or be embodied in the form of computer-implemented processes and apparatuses for practicing those processes. Implementations also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that embodies all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

A. Profile Management

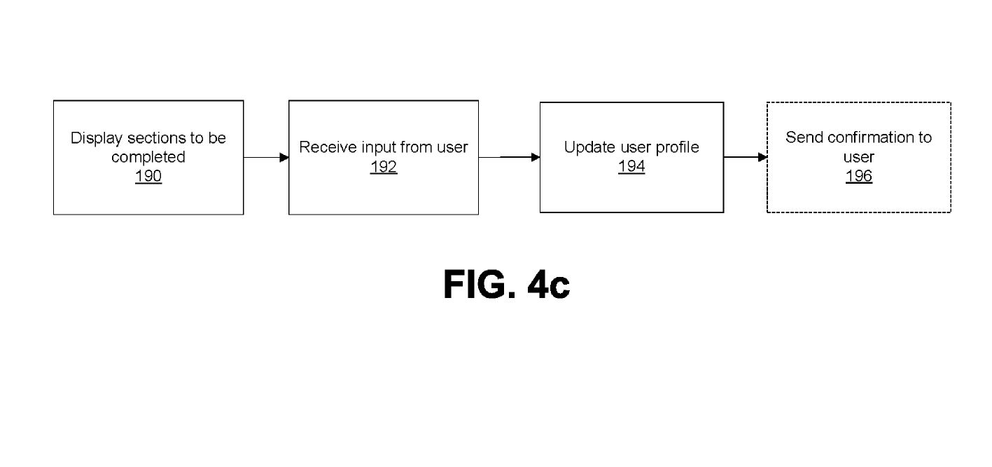

FIG. 4a illustrates a sample process flow for user profile management for a new user to the system. The system receives a profile creation request from a new user (step 100), for example via a webpage. The system then displays a sign up page where the user can input information for creating the profile (step 102). The information for creating the profile includes for example, first and last name, city, occupation, employer, education, experience, etc. The system first receives the information (step 104) and then it validates and saves the information (step 106). The system validates the user's input by checking that all required fields are filled in with the proper type of data. Upon successful validation of the new profile information, the system sends the user a confirmation message to confirm the entered profile information (step 108) and then receives a return confirmation when the user accepts the confirmation message (step 110). After the user confirms the profile information, the system creates a profile for the user and stores the information in the database (step 112). Optionally, the system may send the user a further message confirming that the profile has been created (step 114).

FIG. 4b illustrates a sample process flow for user profile management for an existing user. The system receives the existing user's login information, for example via a webpage (step 120). The login information may include a user name and a password. The system validates the login information by finding a match for the login information in the database and locates the associated user profile (step 122). Upon successful validation of the login information, the system displays the associated profile information to the user (step 124).

The user may wish to modify her profile information. When the system receives a request to modify her profile information (step 126), the system displays editable fields of the profile to the user and allows the user to modify the editable fields (step 128). Once the system receives the modifications submitted by the user (step 130), the system validates the modifications (step 132). Upon successful validation of the modifications, the system sends a validation confirmation to the user (step 134) and if the user accepts the validation confirmation, the system receives a return validation confirmation (step 136) and proceeds to update the user profile in the database (step 138). Optionally, the system may send a confirmation notice to the user (step 140).

FIG. 4c illustrates a sample process flow for updating a user profile as prompted by the system. The system displays the profile sections that need to be completed by the user, for example via a webpage (step 190). Once the system receives the user's input for the sections (step 192), the system updates the user's profile in the database (step 194). The system may optionally send a confirmation to the user to confirm that her profile has been updated (step 196).

B. Payment

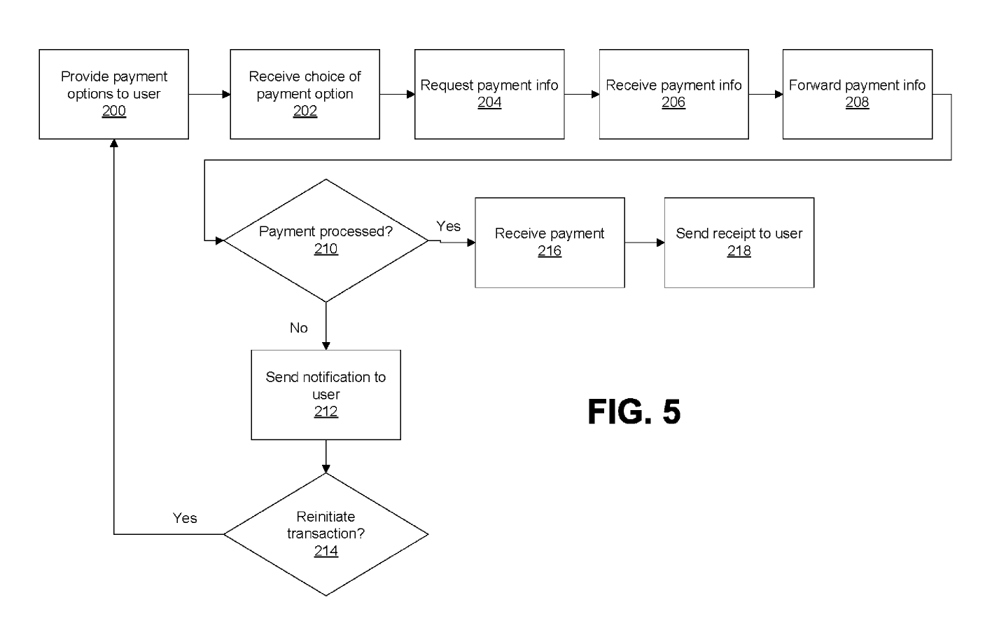

FIG. 5 illustrates a sample process flow for making a payment via the system. The system provides payment options to the user (step 200), for example via a webpage. The payment options include for example credit cards, gift cards, PayPal™, etc. The system receives the user's choice of payment option (step 202) and then requests the payment details (step 204). The payment details include for example card number, expiry date, security code, PayPal login information, etc.

The system receives the payment details (step 206) and then forwards the payment details to a payment system (step 208). In one embodiment, the payment system is a black box system which is used to process electronic payments. The payment system may be a third party system to which the system can connect via the network for processing electronic payments. The payment system may also be part of the system.

The system checks if the payment was successfully processed (step 210), for example by receiving confirmation information from the payment system. If the payment is not processed successfully, the system sends a notification to the user (step 212) and asks the user whether to reinitiate the payment process (step 214). If the system receives confirmation from the user to reinitiate the payment process, the system directs the user to the start of the process by providing payment options to the user (step 200). If the payment is processed successfully, the system receives the payment (step 216) and sends a receipt to the user (step 218).

C. Crowd Funding

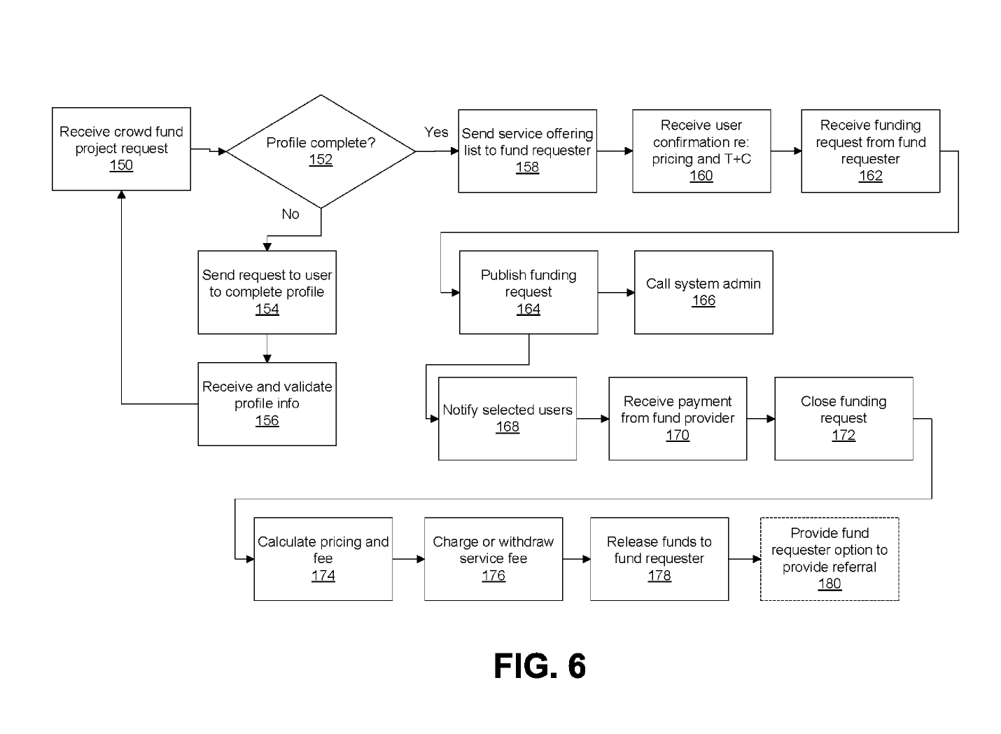

FIG. 6 illustrates a sample process flow for crowd funding. The system receives a crowd fund project request from a user (step 150). The system then checks the user's profile to see whether the profile sections required for submitting crowd funding projects are complete (step 152). The profile information required for submitting a crowd funding project includes for example basic user information, company information, work experience, education, references, and other credentials and/or certifications. The system may further require that the user has a certain status or level of accomplishment or reputation (e.g. has earned a certain badge) before allowing the user to proceed.

If the required profile sections are not complete, then the system sends a request to the user to complete the missing information on her profile (step 154) in accordance with the above-described process for updating a user profile (FIG. 4c). Upon receiving the missing information and successfully validating same (step 156), the user can resubmit the crowd fund project request and the system receives the request (step 150).

If the required profile sections are complete, the system then sends the user (“fund requester”) a list of service offerings with pricing details along with the corresponding terms and conditions (step 158). Once the system receives the user's selection of service, and confirmation that she agrees to the pricing of the selected service, and the terms and conditions (step 160), and receives a funding request from the fund requester (step 162), the system publishes the funding request to all or selected users of the system through its infrastructure (step 164). The funding request is also saved in the database, in association with the fund requester's profile. The publishing of the funding request triggers the system to automatically place a call to the system administrator, e.g. marketing department, which then contacts the fund requester to offer additional services (step 166). The “call” is preferably an electronic signal, message, and/or notification that is sent to the system of the marketing department and is processed by an application or software, but it may also be a telephone call. Preferably, the marketing department then automatically notifies the user electronically (e.g. email, text messaging, etc.) to offer additional services. After publishing the funding request, the system sends a notification to selected users (e.g. subscribers who indicated in their profiles that they are interested in providing funding) about the newly published crowd funding project (step 168).

The selected users can review the details of the crowd funding project and decide whether to provide funding. If a user decides to provide funding, the system receives payment from the user (“fund provider”) in accordance with the payment process described above (step 170). In one embodiment, a time limit to provide funding may be set by the fund requester and/or the system and the system may receive payment from fund providers until time limit expires.

When the funding request expires and/or closes (step 172), whether automatically or selectively by the fund requester and/or system, the system calculates the service fee based upon the pricing, terms and conditions as previously agreed to by the fund requester (step 174). The system charges the fund requester the service fee in accordance with the payment process described above or withdraws the service fee directly from the money raised (step 176). The system then releases the (remaining) raised funds to the fund requester (step 178).

The system may optionally provide the fund requester with the option to provide referral to the fund provider(s). If the fund requester wishes to provide referral to the fund provider(s), then the system launches the referral process, which is described hereinbelow.

### EXAMPLE 2

| Description | Operation | Pricing |
|---|---|---|
| Ideas and plans are posted by any | Once submitted, the ideas and | For example, an industry standard |
| user wanting to access the system | plans are categorized and then | fee of 9% may be taken from all |
| to solicit funding from other | published with deadlines to | funds received for successful |
| users | relevant audiences, such as active | funding rounds (i.e. those |
| | opt-in subscribers of the system | reaching funding objectives). An |
| | who have expressed an interest in | administration fee may also be |
| | this type of opportunity and/or in | applied to those that chose to |
| | a certain specialized field. | have their offer published. |

D. Referral

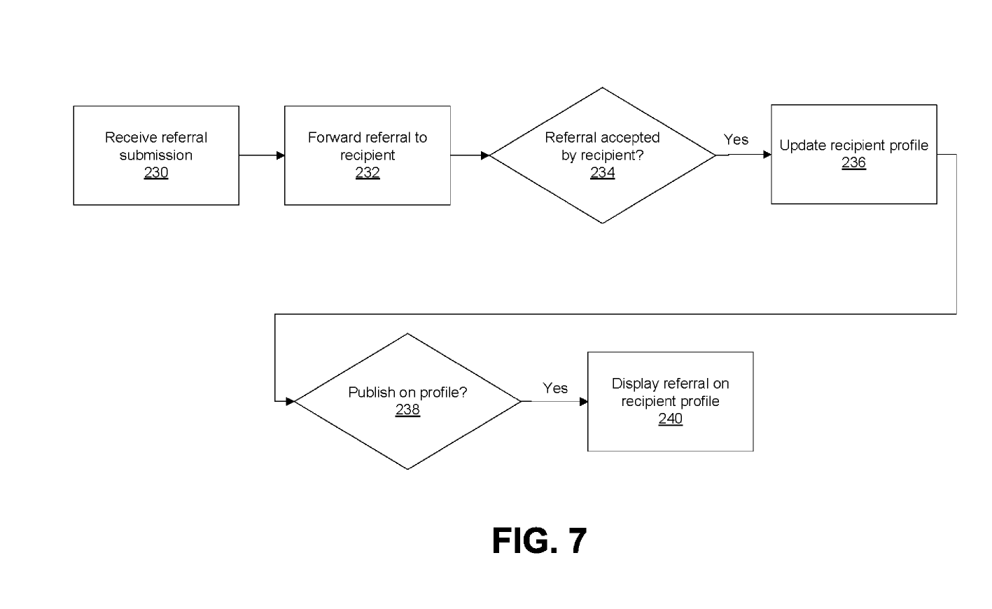

FIG. 7 illustrates a sample process flow for providing a referral. First, the system receives a referral submission from a user (“referree”) (step 230). The submission includes information regarding which user is to receive the referral (“recipient of the reference”). The system then forwards the referral submission to the intended reference recipient (step 232). The recipient can choose to accept or reject the referral. If the referral is accepted by the recipient (step 234), the system updates the recipient's profile information in the database to include the referral (step 236). The system then asks the recipient whether to publish the referral on the recipient's profile so that the referral is visible to other users (step 238). If the recipient wants the referral published, the system then displays the referral on the recipient's profile (step 240).

E. Crowd Sourcing

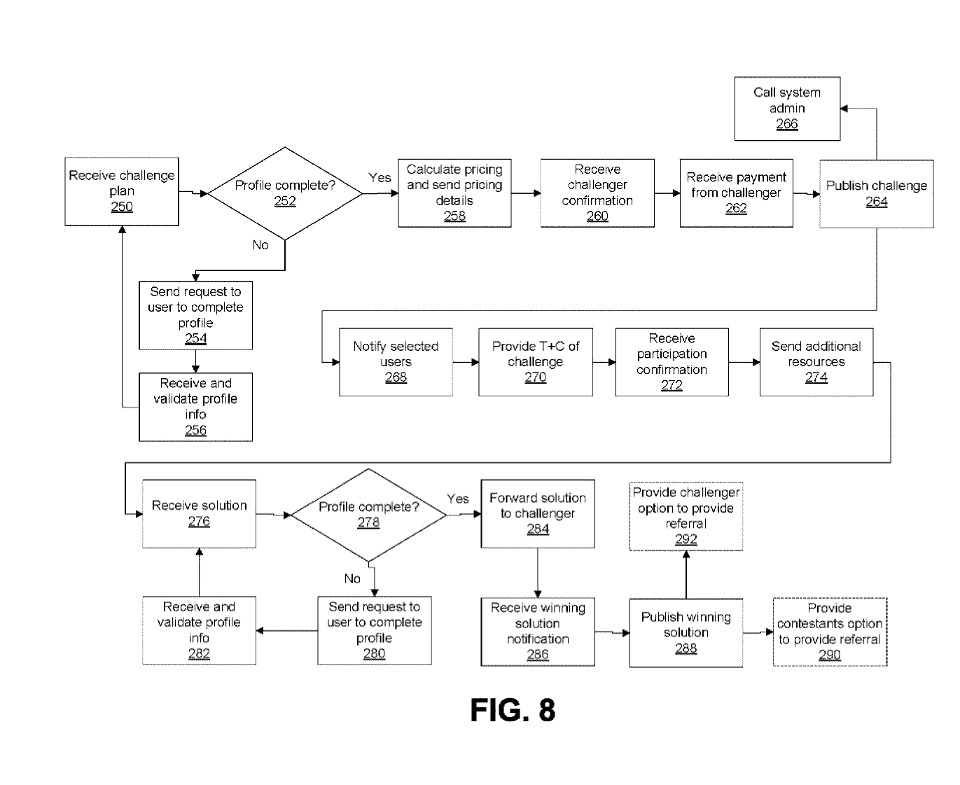

FIG. 8 illustrates a sample process flow for crowd sourcing. The system receives a crowd sourcing challenge plan from a user (“challenger”) (step 250). The system then checks whether the sections of the challenger's profile required for submitting the crowd sourcing challenge are complete (step 252). The profile information required for submitting a crowd sourcing challenge includes for example basic user information, company information, work experience, education, references, and other credentials and/or certifications. The system may further require that the challenger has a certain status or level of accomplishment or reputation (e.g. has earned a certain badge) before allowing the user to proceed.

If the required profile sections are not complete, the system sends a request to the challenger to complete her profile (step 254) in accordance with the above-described process for updating a user profile (FIG. 4c). Upon receiving the missing information and successfully validating same (step 256), the user can resubmit the crowd sourcing challenge request and the system receives the request (step 250).

If the required profile sections are complete, the system then calculates service fee and sends the challenger the service fee pricing details for the system to host the challenge (step 258). Once the challenger accepts the pricing (step 260), the system charges the challenger the service fee in accordance with the above-described payment process to receives the service fee from the challenger (step 262).

Upon successful receipt of payment from the challenger, the system publishes the challenge through its infrastructure (step 264). The challenge is also saved in the database, in association with the challenger's profile. The publishing of the crowd sourcing challenge triggers the system to automatically place a call to the system administrator (step 266), e.g. marketing department, which then electronically notifies all or selected subscribers of the system of the newly published challenge (step 268).

The notified subscribers can review the details of the challenge and the system provides the terms and conditions of participating in the challenge (step 270). If a subscriber decides to participate in the challenge, the subscriber (“contestant”) accepts the terms and conditions and a participation confirmation is sent to the system. Once the system receives the participation confirmation from the contestant (step 272), the system sends the contestant additional resources required to participate in the challenge (step 274).

The contestant can send a solution to the system to address the challenge. Once the system receives a solution from the contestant (step 276), the system checks if the required sections of the contestant's profile are complete (step 278). The profile information required for submitting a solution includes for example basic user information, company information, work experience, education, references, and other credentials and/or certifications. If the required profile sections are not complete, the system sends a request to the contestant to complete her profile (step 280) in accordance with the above-described process for updating a user profile (FIG. 4c). Upon receiving the missing information and successfully validating same (step 282), the contestant can resubmit the solution and the system receives the solution (step 276).

If the required profile sections are complete, the system forwards the solution to the challenger (step 284). The challenger can review all the submitted solutions and can select the winning solution by vetting, rating and short-listing the solutions. Once the challenger selects a winning solution, the challenger notifies the system and the system receives the notification (step 286) and then publishes the solution for viewing by the contestants (step 288). Optionally, the challenger may give an award to the winning contestant. The release and delivery of the award to the winning contestant may be done through the system and the award may be in the form of an electronic payment.

After publishing the winning solution, the system may optionally provide the contestants with the option to provide referral to the challenger (step 290) and the challenger with the option to provide referral to any of the contestants (step 292). If any of the contestants wishes to provide a referral to the challenger, then the system launches the referral process, which is described above. If the challenger wishes to provide referral to any of the contestants, the system then launches the referral process.

### EXAMPLE 3

| Description | Operation | Pricing |
|---|---|---|
| Any user may post a challenge | Challenges are submitted and | For example, the challenger may |
| on the system to seek information, | then categorized and published | pay a per qualified response fee. |
| communication, and interaction | with deadlines to relevant | An administration fee may also |
| on whatever activity or topic they | audiences, such as active opt-in | apply (e.g. zero at year 1, rising |
| desire. | subscribers of the system who | to $5000 at year 3) to those that |
| | have expressed an interest in this | chose to have their challenge |
| | type of challenge or in a certain | published. |
| | specialized field. | |

### EXAMPLE 4

| Description | Operation | Pricing |
|---|---|---|
| Post-secondary institutions may | Postings are made in categorized | For example, rates to students |
| post challenges for students to | forums on the system for viewing | may be determined by the |
| work on. | by students with suitable | challenger, with the system taking |
| | credentials to complete and/or | a service fee for funds on deposit |
| | be part of the challenge. | and deployed under predetermined |
| | | rules of fulfillment. |

### EXAMPLE 5

| Description | Operation | Pricing |
|---|---|---|
| Not-for-Profit organizations post | Postings are categorized and | For example, fees may include |
| challenges as an agent for other | may be published. | response fees, admin fees, and/or |
| parties. | | service fees depending on client |
| | | requirements. |

### EXAMPLE 6

| Description | Operation | Pricing |
|---|---|---|
| Solutions, prototypes, pilot | The system allows access for | For example, a cost per download |
| project, etc. can be displayed | users to try the technical | (and/or use) model may be |
| and interacted with through the | solutions and share feedback | applied, such that the fee is |
| system, for ‘hands-on’ | with the poster. | representative of the volume and |
| experimentation and trials. | | value of the audience reached. |

F. Asset Sharing

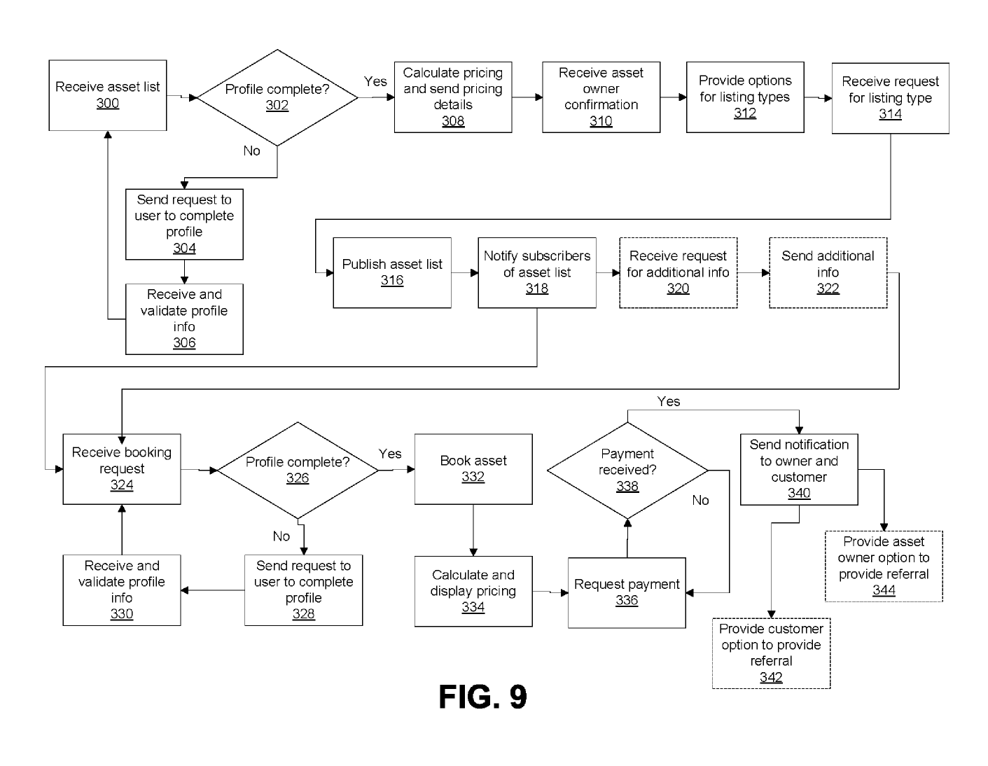

FIG. 9 illustrates a sample process flow for asset sharing. The system receives an asset list from a user (“asset owner”). The asset list includes details about the assets and the details may be in the form of text, pictures, videos, etc. (steps 300). The system checks whether the sections of the asset owner's profile required for sharing assets have been completed (step 302). If the required profile sections are not complete, the system sends a request to the asset owner to complete her profile (step 304) in accordance with the above-described process for updating a user profile (FIG. 4c). Upon receiving the missing information and successfully validating same (step 306), the asset owner can resubmit the asset list and the system receives the asset list (step 300).

If the required profile sections are complete, the system then calculates service fee and sends the asset owner the cost and pricing details based on the asset list submitted (step 308). Once the challenger accepts the pricing (step 310), the system provides the asset owner with options for listing types (step 312). Listing types may include for example, types of licences, duration, terms of acceptable use, etc. The owner selects the listing types and then accepts the terms and conditions associated with asset sharing. The system receives a request from the owner with the listing type selection and a confirmation of acceptance of the terms and conditions (step 314).

Once the system receives the request from the owner, the system publishes the asset list through its infrastructure (step 316). The asset list is saved in the database, in association with the asset owner's profile. The system then notifies all or selected users of the system of the new asset list (step 318). Users can view the asset information and may request further information about any of the assets. Upon receiving a request for additional information (step 320), the system sends additional information to the user, if available (step 322). The system may optionally forward the request for additional information to the asset owner, and receive additional information from the asset owner and forward same to the user.

At step 324, the system receives a request from a user (“customer”) to book an asset. Upon receiving the booking request, the system checks whether the required sections of the customer's profile for booking an asset are complete (step 326). If the required profile sections are not complete, the system sends a request to the customer to complete her profile (step 328) in accordance with the above-described process for updating a user profile (FIG. 4c). Upon receiving the missing information and successfully validating same (step 330), the customer can resubmit the booking request and the system receives the request (step 324).

If the required profile sections are complete, then the system launches the booking process (step 332), as described below. Based on the length of time for which the customer wants to rent the asset, the system calculates the pricing and displays it to the customer (step 334). The system then requests payment from the customer by launching the above-described payment process (step 336). If the payment is made successfully (step 338), the system sends a notification to both the asset owner and the customer (step 340), so that the owner proceeds to share the asset with the customer on a date and time agreed upon by both parties.

The system may optionally provide the customer with the option to provide referral to the asset owner (step 342) and the asset owner with the option to provide referral to the customer (step 344). If the customer wishes to provide referral to the owner, then the system launches the referral process, which is described above. If the owner wishes to provide referral to the customer, the system then launches the referral process.

### EXAMPLE 7

| Description | Operation | Pricing |
|---|---|---|
| Any user may post their available | The asset owner retains full | For example, the asset owner is |
| assets on their profile, with a | ownership and control of their | free to charge as it sees fit, but |
| description of the associated fees | assets and facility, and charges | may process payments through |
| and operational practices. | the customer through the system. | the system and the system may |
| | | charge an administration fee from |
| | | the payment. |

G. Booking an Asset or Skill

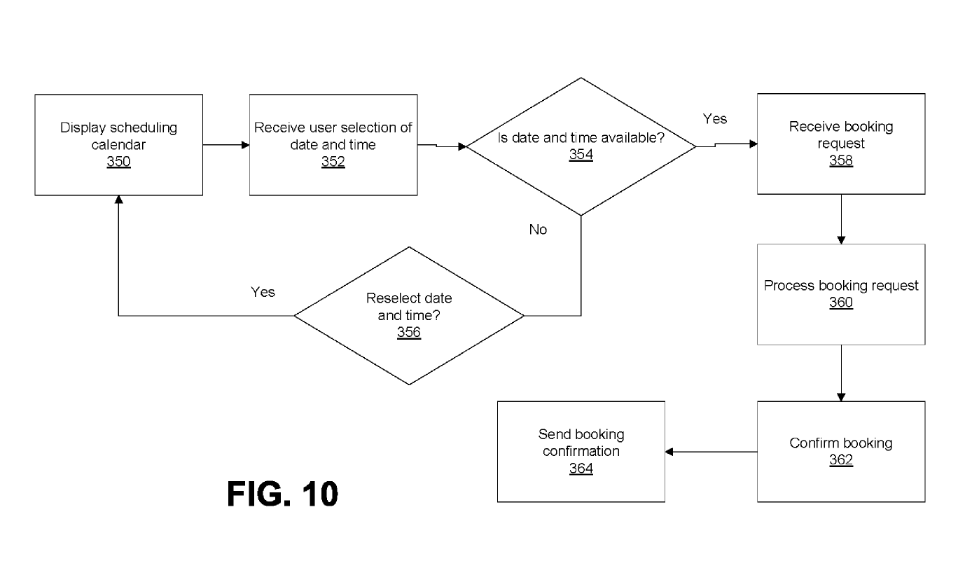

FIG. 10 illustrates a sample process flow for booking an asset or skill. The system displays the scheduling calendar to a user (“customer”) for a particular asset or skill (step 350). The system receives the customer's selection of date and time (step 352) and then checks whether the asset or skill is available at the selected date and time (step 354). If the selected date and time are not available, the system asks the customer if she wants to select another date and time (step 356). If the customer wants to select another date and time, the system displays the scheduling calendar (step 350).

If the selected date and time are available, the system receives a booking request from the customer (step 358) and then processes the booking request (step 360). In one embodiment, the system processes the booking request by sending a notification to the user who offered the asset or skill and receiving an acknowledgment from the user for same. Once the booking request is processed, the system confirms the booking (step 362) and sends a confirmation to the customer (step 364).

H. Knowledge Mobilization

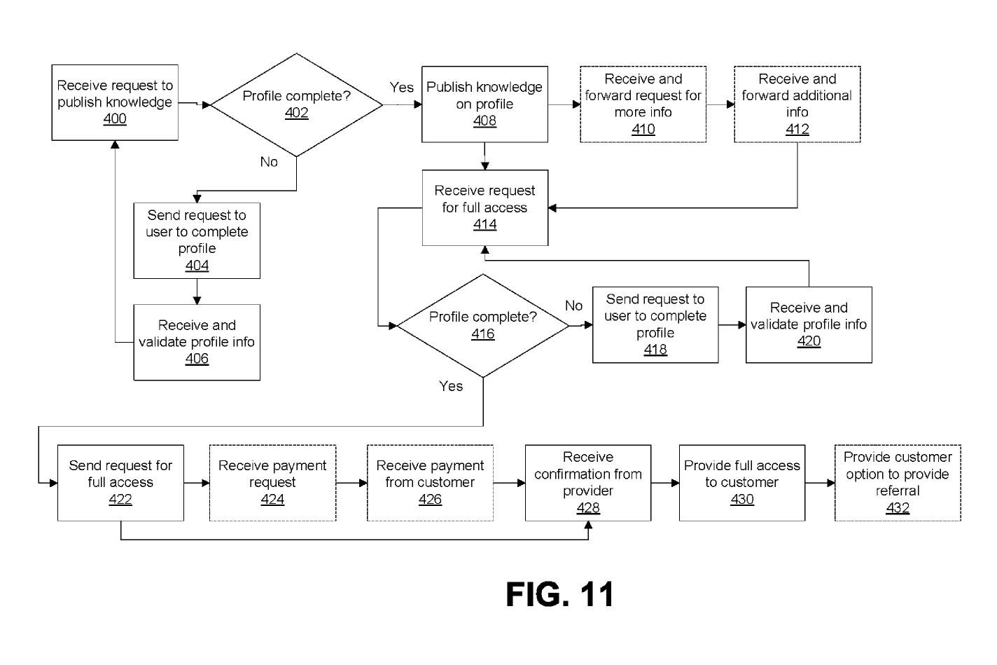

FIG. 11 illustrates a sample process flow for knowledge mobilization. A user (“provider”) uploads knowledge and/or resources to the system and the system receives a request from the provider to publish her knowledge and/or resources on her profile (step 400). The system then checks whether the required sections of the provider's profile for sharing knowledge and resources are complete (step 402). The profile information required for sharing knowledge and/or resources includes for example basic user information, company information, work experience, education, references, and other credentials and/or certifications. The system may further require that the provider has a certain status or level of accomplishment or reputation (e.g. has earned a certain badge) before allowing the user to proceed.

If the required sections are not complete, the system sends a request to the provider to complete her profile (step 404) in accordance with the above-described process for updating a user profile (FIG. 4c). Upon receiving the missing information and successfully validating same (step 406), the provider can resubmit her request to publish knowledge and/or resources and the system receives the request (step 400). If the required profile sections are complete, the system publishes the knowledge and/or resources uploaded by the provider on the provider's profile (step 408). The knowledge and/or resources are stored in the database, association with the provider's profile.

Once published, the knowledge and/or resources can be accessed and viewed by other users (“customers”) and any of the customers can request more information about the knowledge and/or resources from the provider. If a customer is requesting more information, the system receives the customer's request and forwards it to the provider (step 410). If the system receives a response to the request from the provider, the system forwards same to the customer (step 412).

If the customer does not require further information or has received a satisfactory response regarding the requested additional information, the customer can send a request to the Provider to gain full access to the knowledge and/or resources and the system receives this request at step 414. Upon receiving the customer's request, the system checks whether the required sections of the customer's profile for requesting access to knowledge/resources are complete (step 416). The profile information required for accessing knowledge/resources includes for example basic user information, company information, work experience, education, payment information. The system may further require that the customer has a certain points level, status, or level of accomplishment or reputation (e.g. has earned a certain badge) before allowing the user to proceed.

If the required sections are not complete, the system sends a request to the customer to complete her profile (step 418) in accordance with the above-described process for updating a user profile (FIG. 4c). Upon receiving the missing information and successfully validating same (step 420), the provider can resubmit her request for full access of the knowledge and/or resources and the system receives the request (step 414). If the required profile sections are complete, the system sends a request to the provider for full access of the knowledge and/or resources (step 422). If the provider agrees to grant full access to the customer, the system receives a confirmation (step 428).

The provider may optionally charge the customer for full access of the knowledge and/or resources by sending a payment request to the system. The system receives this request at step 424 and launches the payment process as described above to request payment from the customer. Once payment is successfully processed, the provider sends the system a confirmation and the system receives the confirmation at step 428.

Upon receiving confirmation from the provider, the system grants the customer full access to the knowledge and/or resources (step 430). Optionally, the system may provide the customer the option to give the provider a referral (step 432). If the customer wishes to provide referral to the provider, the system then launches the referral process as described above.

### EXAMPLE 8

| Description | Operation | Pricing |
|---|---|---|
| Users place creative assets (e.g. | Members may access and use the | For example, a cost per download |
| applications, software, hardware, | creative assets on per-use, | model may be applied, such that |
| etc.) on the system that can be | subscription, or download-to-own | the fee is representative of the |
| accessed and used by other users | basis. | volume and value of the audience |
| of the system. | | reached. |

### EXAMPLE 9

| Description | Operation | Pricing |
|---|---|---|
| Users post content on the system | Users make their own content, | For example, access to the site |
| that is of relevance and help to a | log on to the system, and upload | may be free of charge, as is |
| certain audience. Multimedia | to relevant categorized forums on | uploading and posting of relevant |
| formats are available, including | the system. Other users may then | content. Users are encouraged |
| video clips, reports, presentations, | add to, comment, rate and | and incented to add content, as |
| and interactive tools and | provide feedback on the content. | the highest viewed and most |
| applications. | | popular may eventually lead to |
| | | advertising revenues (for both the |
| | | user and the system). |

I. Skill Sharing

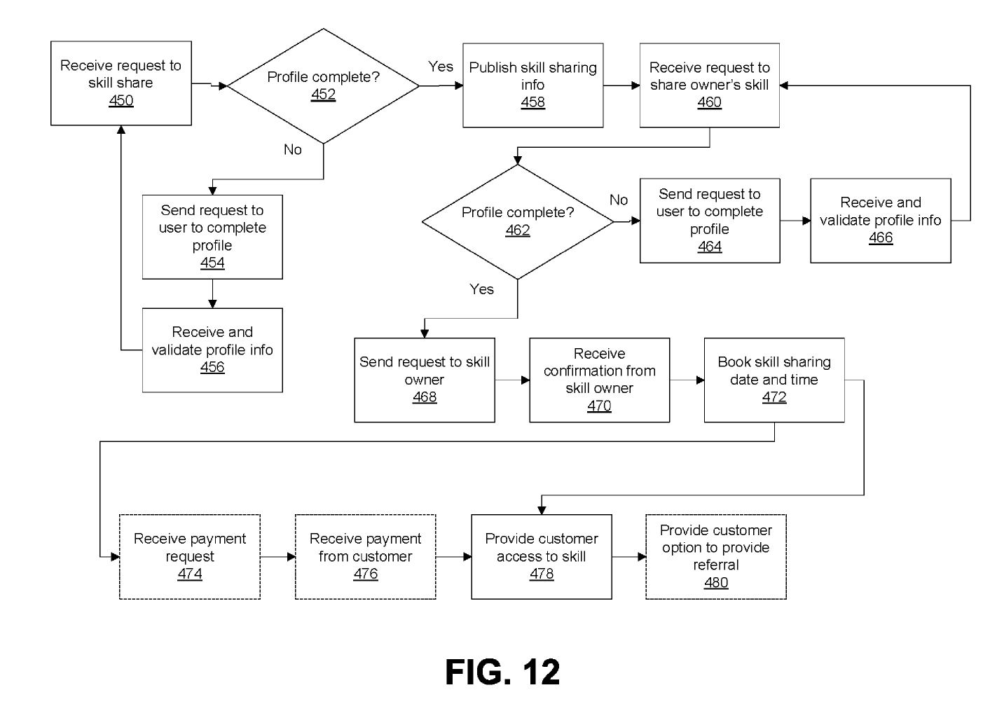

FIG. 12 illustrates a sample process flow for skill sharing wherein a user (“skill owner”) sends the system request for skill sharing. The skill owner uploads skill sharing information to her profile and sends a request to publish the information. The system receives the request for skill sharing from the skill owner (step 450). The system checks whether the necessary sections of the skill owner's profile for skill sharing are complete (step 452). The profile information required for submitting a skill sharing request includes for example basic user information, company information, work experience, education, references, and other credentials and/or certifications. The system may further require that the skill owner has a certain points level, status, or level of accomplishment or reputation (e.g. has earned a certain badge) before allowing the user to proceed.

If the required sections are not complete, the system sends a request to the skill owner to complete her profile (step 454) in accordance with the above-described process for updating a user profile (FIG. 4c). Upon receiving the missing information and successfully validating same (step 456), the skill owner can resubmit her request to skill share and the system receives the request (step 450). If the required profile sections are complete, the system publishes the skill owner's skill sharing information (step 458). The skill sharing information is saved in the database, in association with the skill owner's profile.

Once published, the skills sharing information can be accessed and viewed by other users (“customers”). If a customer likes the skills mentioned on the skill owner's profile, the customer can send a request for skill sharing and the system receives the request (step 460). The system checks whether the necessary sections of the customer's profile for requesting skill sharing are complete (step 462). The profile information required for requesting skill sharing includes for example basic user information, company information, and payment information. The system may further require that the customer has a certain points level, status, or level of accomplishment or reputation (e.g. has earned a certain badge) before allowing the user to proceed.

If the required sections are not complete, the system sends a request to the customer to complete her profile (step 464) in accordance with the above-described process for updating a user profile (FIG. 4c). Upon receiving the missing information and successfully validating same (step 466), the customer can resubmit her request to share the owner's skill and the system receives the request (step 460). If the required profile sections are complete, the system sends the customer's request to the skill owner (step 468).

Upon receiving the skill sharing request, the skill owner can decide whether or not to accept the request and share her skill. If the skill owner decides to share the skill, the skill owner sends a confirmation to the system and the system receives the confirmation at step 470. Once the system receives the skill owner's confirmation, the system launches the booking process, as described above, to help the owner and customer set up a date and time for skill sharing (step 472).

After the booking is confirmed, the skill owner may optionally charge the customer for sharing the skill. If the skill owner wishes to charge the customer, the skill owner sends a payment request to the system and the system receives the request at step 474. Upon receiving the payment request, the system launches the payment process and requests payment from the customer. When the payment is processed successfully (step 476) or when the booking process is complete (step 472) and payment is not required, the system provides the customer access to the skill at the scheduled date and time (step 478). Optionally, the system may provide the customer the option to give the skill owner a referral (step 480). If the customer wishes to provide referral to the skill owner, the system then launches the referral process as described above.

In another embodiment, skill sharing may be initiated by a customer. A customer may initiate the skill sharing process by sending a request for the skills of a skill owner who has not submitted a request to skill share. In this embodiment, the process is initiated when the system receives a request to share an owner's skill from a customer (step 460). The remainder of the process is carried out the same way with regards to steps 462 to 480, as described above.

### EXAMPLE 10

| Description | Operation | Pricing |
|---|---|---|
| Users develop a portfolio to | Users make their own content, log | For example, uploading to the |
| showcase their talents and to | on to the system, and upload the | site may be free of charge. |
| express their capabilities to | content to the system. The system | Enhanced services (e.g. unique |
| prospective challengers or | may, through affiliates, offer | URL that will remain within the |
| enquirers. | facilities to make professional | system) may be charged on an |
| | portfolios for the users. | ongoing basis. |

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. For US patent properties, it is noted that no claim element is to be construed under the provisions of 35 USC 112, sixth paragraph, unless the element is expressly recited using the phrase “means for” or “step for”.

1. A system for providing a collaboration space over a communication network, the system comprising:
a database to store a user profile and user activity history for a first user, the user profile comprising login information, user information, and user uploaded content, which comprises one or more of: (i) a crowd funding request; (ii) a crowd source challenge; (iii) information about an asset; (iv) knowledge; and (v) information about a skill; and
a processor connected to the database, the processor configured to:
generate and publish the user profile based on the user information and user uploaded content, to render the user profile accessible to other users via the communication network;
receive and process a request from a second user to: (i) submit funding to the first user; (ii) submit a solution to the first user; (iii) share the asset; (iv) access the knowledge; and/or (v) share the skill; and
receive and process a request from the second user to provide a referral to the first user, wherein the database stores the referral and associates the referral with the user profile, and wherein the processor publishes the referral on the user profile upon confirmation from the first user.

2. The system of claim 1 wherein the processor is further configured to receive and process a request from the first user to provide a second referral to the second user, and to publish the second referral on a user profile of the second user upon confirmation from the second user, and wherein the database stores the second referral and associates the second referral with the user profile of the second user.

3. The system of claim 1 wherein the processor is further configured to request and process a payment to and/or from the first user and/or the second user.

4. The system of claim 1 wherein the processor is further configured to receive a request for additional information about the asset from the second user and forward the request to the first user; and to receive the additional information from the first user and forward same to the second user.

5. The system of claim 1 wherein the processor is further configured to receive and process a booking request from the second user for booking the asset or the skill for an available date and time selected by the second user.

6. The system of claim 1 wherein the processor is further configured to: (i) award points or a virtual badge to the first user, and the database stores the points or badge and associates the points or badge with the user profile; and/or (ii) award points or a second virtual badge to the second user, and the database stores the points or second badge and associates the points or second badge with a user profile of the second user.

7. The system of claim 3 wherein the processor is further configured to allow the payment to be made at least in part with points.

8. A method for providing a collaboration space over a communication network, the method comprising:
storing to a database a user profile for a first user, the user profile comprising login information and user information;
storing to the database an activity history of the first user;
generating and publishing the user profile based on the user information, to render the user profile accessible to other users via the communication network;
uploading content provided by the first user, and storing same in the database, the content comprising one or more of: (i) a crowd funding request; (ii) a crowd source challenge; (iii) information about an asset; (iv) knowledge; and (v) information about a skill;
publishing the content on the user profile upon request from the first user;
receiving and processing a request from a second user to: (i) submit funding to the first user; (ii) submit a solution to the first user; (iii) share the asset; (iv) access the knowledge; and/or (v) share the skill;
receiving and processing a request from the second user to provide a referral to the first user;
storing to the database the referral and associating the referral with the user profile; and
publishing the referral on the user profile upon confirmation from the first user.

9. The method of claim 8 further comprising receiving and processing a request form the first user to provide a second referral to the second user; publishing the second referral on a user profile of the second user upon confirmation from the second user; and storing to the database the second referral and associating the second referral with the user profile of the second user.

10. The method of claim 8 further comprising requesting and processing a payment to and/or from the first user and/or the second user.

11. The method of claim 8 further comprising receiving a request for additional information about the asset from the second user; forwarding the request to the first user; and receiving the additional information from the first user and forwarding same to the second user.

12. The method of claim 8 further comprising receiving and processing a booking request from the second user; and booking the asset or the skill for an available date and time selected by the second user.

13. The method of claim 8 further comprising one or both of: (i) awarding points or a virtual badge to the first user, and storing to the database the points or badge and associating the points or badge with the user profile; (ii) awarding points or a second virtual badge to the second user, and storing to the database the points or second badge and associating the points or second badge with a user profile of the second user.

14. The method of claim 10 further comprising allowing the user to pay at least a part of the payment with points in the corresponding user profile.

15. The system of claim 6 wherein the processor is further configured to allow the payment to be made at least in part with points.

16. The method of claim 13 further comprising allowing the user to pay at least a part of the payment with points in the corresponding user profile.
